(19) United States
(12) Patent Application Publication
(10) Pub. No.: US 2025/0385398 A1
(43) Pub. Date: Dec. 18, 2025

(54) ENERGY STORAGE DEVICE

(71) Applicant: GS Yuasa International Ltd., Kyoto-shi (JP)

(72) Inventor: Riku AIKATA, Kyoto-shi (JP)

(21) Appl. No.: 19/260,771

(22) Filed: Jul. 7, 2025

Related U.S. Application Data
(63) Continuation of application No. PCT/JP2024/000532, filed on Jan. 12, 2024.

(30) Foreign Application Priority Data
Jan. 13, 2023 (JP) 2023-003742

(51) Int. Cl. H01M 50/533; H01G 11/70; H01G 11/78; H01M 50/103

(52) U.S. Cl. CPC H01M 50/533; H01M 50/103; H01G 11/70; H01G 11/78

(57) ABSTRACT

An energy storage device includes an electrode body, a current collector electrically connected to the electrode body, a container accommodating therein the electrode body and the current collector, and a terminal attached to the container and electrically connected to the current collector. The container includes a container body and a container lid joined to the container body. The container body includes a first wall portion and a second wall portion extending from at least a portion of a peripheral edge of the first wall portion. The current collector includes a terminal connection portion joined to the terminal, an intermediate portion extending from the terminal connection portion along the first wall portion, a bent portion facing the terminal connection portion from the intermediate portion, and an electrode body connection portion extending from the bent portion to approach the terminal connection portion and joined to the electrode body.

### CROSS REFERENCE TO RELATED APPLICATIONS

This application claims the benefit of priority to Japanese Patent Application No. 2023-003742 filed on Jan. 13, 2023 and is a Continuation application of PCT Application No. PCT/JP2024/000532 filed on Jan. 12, 2024. The entire contents of each application are hereby incorporated herein by reference.

### BACKGROUND OF THE INVENTION

### 1. Field of the Invention

The present invention relates to energy storage devices.

### 2. Description of the Related Art

Conventionally, there has been known a flat wound-type secondary battery including a wound group and a cylindrical battery can for accommodating therein the wound group (refer to JP 2013-161555 A). During manufacturing, the wound group is inserted from an open end of the battery can and accommodated therein.

### SUMMARY OF INVENTION

When the wound group is inserted, the wound group may be damaged by friction received from the battery can.

Example embodiments of the present invention provide energy storage devices each capable of reducing or preventing damage to an electrode body during manufacturing.

An energy storage device according to an example embodiment of the present invention includes an electrode body, a current collector electrically connected to the electrode body, a container accommodating therein the electrode body and the current collector, and a terminal attached to the container and electrically connected to the current collector, in which the container includes a container body and a container lid joined to the container body, the container body includes a first wall portion and a second wall portion extending from at least a portion of a peripheral edge of the first wall portion, and the current collector includes a terminal connection portion joined to the terminal, an intermediate portion extending from the terminal connection portion along the first wall portion, a bent portion facing the terminal connection portion from the intermediate portion, and an electrode body connection portion extending from the bent portion to approach the terminal connection portion and joined to the electrode body.

According to the energy storage devices of example embodiments of the present invention, it is possible to reduce or prevent damage to the electrode body during manufacturing.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an external appearance of an energy storage device according to an example embodiment of the present invention.

FIG. 2 is an exploded perspective view obtained by disassembling an energy storage device according to an example embodiment of the present invention and showing elements thereof.

FIG. 3 is a cross-sectional view illustrating a structure of connection between a terminal according to an example embodiment of the present invention and a current collector and the like.

FIG. 4 is a perspective view illustrating a configuration of an electrode body according to an example embodiment of the present invention.

FIGS. 5A to 5D are explanatory diagrams illustrating a method of manufacturing an energy storage device according to an example embodiment of the present invention.

FIG. 6 is an explanatory diagram illustrating an energy storage apparatus including an energy storage device according to an example embodiment of the present invention.

### DETAILED DESCRIPTION OF THE EXAMPLE EMBODIMENTS

An energy storage device according to an example embodiment of the present invention includes an electrode body, a current collector electrically connected to the electrode body, a container accommodating therein the electrode body and the current collector, and a terminal attached to the container and electrically connected to the current collector, in which the container includes a container body and a container lid joined to the container body, the container body includes a first wall portion and a second wall portion extending from at least a portion of a peripheral edge of the first wall portion, and the current collector includes a terminal connection portion joined to the terminal, an intermediate portion extending from the terminal connection portion along the first wall portion, a bent portion facing the terminal connection portion from the intermediate portion, and an electrode body connection portion extending from the bent portion to approach the terminal connection portion and joined to the electrode body.

Accordingly, during manufacturing, one end portion (the terminal connection portion) of the current collector is joined to the terminal in a state in which the one end portion overlaps the second wall portion of the container body, and an other end portion (the electrode body connection portion) of the current collector extends upwardly with respect to the first wall portion of the container body. After that, after joining the electrode body to the electrode body connection portion, a portion between the one end portion of the current collector and the other end portion of the current collector is bent, such that the electrode body connection portion and the electrode body approach the terminal connection portion. By doing so, in a state in which the electrode body connection portion and the electrode body are joined, the electrode body can be smoothly located along the first wall portion of the container body. That is, during manufacturing of such an energy storage device, the electrode body can be smoothly located along the first wall portion. Thus, damage to the electrode body can be reduced or prevented.

In an energy storage device according to an example embodiment of the present invention, the second wall portion may extend from a pair of edge portions opposed to each other in a direction in which the intermediate portion extends among the peripheral edges of the first wall portion.

Accordingly, even in a container body in which the second wall portion extends from the pair of edge portions opposed to each other in the extending direction among the peripheral edges of the first wall portion, it is possible to smoothly dispose the electrode body along the first wall portion during manufacturing. Therefore, even in such a container body, it is possible to reduce or prevent a load applied to the electrode body during manufacturing.

In an energy storage device according to an example embodiment of the present invention, the first wall portion may have a rectangular or substantially rectangular in which adjacent corner portions in a plan view are cut out, and the current collector and the terminal may be attached to the second wall portion corresponding to a cutout portion in the first wall portion.

Since the current collector and the terminal are attached to the second wall portion corresponding to the cutout portion, it is possible to dispose a portion (an active material layer formed portion) which contributes to power generation (storage of electricity) of the electrode body between a pair of such cutout portions. Therefore, a redundant space in the container can be reduced, and energy density of the energy storage device can be increased.

In an energy storage device according to an example embodiment of the present invention, the bent portion may be bent in a V-shape or approximate V-shape.

Accordingly, since the bent portion is bent in a V-shape or approximate V-shape, a total length of the bent portion can be made short. Therefore, it is possible to reduce or prevent an increase in the size of the current collector.

In an energy storage device according to an example embodiment of the present invention, the electrode body connection portion may overlap the intermediate portion in a plan view of the intermediate portion.

Accordingly, since the intermediate portion and the electrode body connection portion overlap one another in a plan view of the intermediate portion, the bent portion can be smoothly bent during manufacturing. Therefore, it is possible to further reduce or prevent the load applied to the electrode body during manufacturing.

Hereinafter, energy storage devices according to example embodiments (including modification examples thereof) of the present invention will be described with reference to the drawings. Example embodiments described below each illustrate a comprehensive or specific example. A numerical value, a shape, a material, a element, a position of arrangement and a form of connection of the elements, a manufacturing process, an order of the manufacturing processes, and the like, which are described in the following example embodiments, are merely examples, and are not intended to limit the present invention. In each of the drawings, dimensions and the like are not strictly illustrated. In the drawings, same or similar elements are assigned an identical reference numeral.

In the following description and the drawings, a direction in which short side surfaces of a container are opposed to each other is defined as an X-axis direction. A direction in which long side surfaces of the container are opposed to each other, i.e., a direction in which a container body and a container lid of the container are located, or a thickness direction of the container, is defined as a Y-axis direction. A direction in which an upper surface and a lower surface of the container are located, or an up-down direction is defined as a Z-axis direction. The X-axis direction, the Y-axis direction, and the Z-axis direction are directions intersecting each other (orthogonal to each other in the present example embodiment). Although there may be a case where the Z-axis direction does not conform to the up-down direction depending on a use mode, the Z-axis direction is described as the up-down direction in the following for convenience of description.

In the following description, an X-axis positive direction indicates a direction of an arrow in the X-axis, and an X-axis negative direction indicates a direction opposite to the X-axis positive direction. The same applies to the Y-axis direction and the Z-axis direction. Hereinafter, the Y-axis direction may also be referred to as a first direction, the X-axis direction may also be referred to as a second direction, and the Z-axis direction may also be referred to as a third direction. Expressions indicating relative directions or postures, such as parallel and orthogonal, include cases where the directions or postures are not parallel or orthogonal in a strict sense. The expression that two directions are orthogonal to each other not only means that the two directions are completely orthogonal to each other, but also means that the two directions are substantially orthogonal to each other, in other words, a difference by several percent or so is included in the scope. In the following description, when the expression “insulate” is used, it is intended as “electrical insulation”.

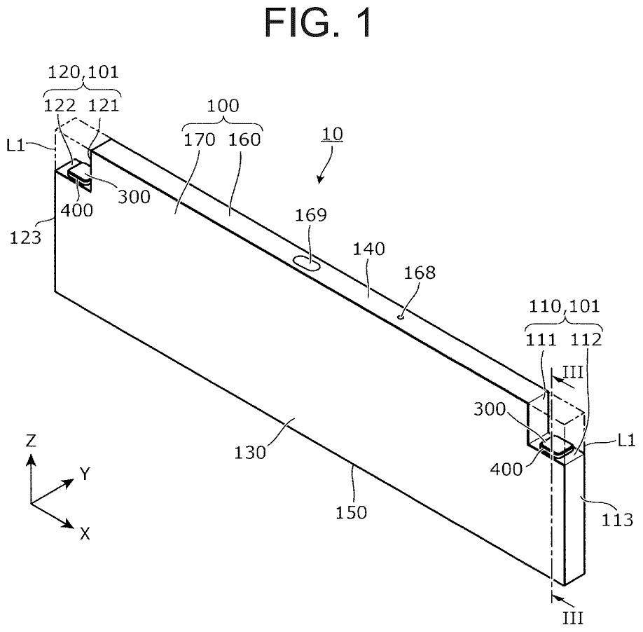

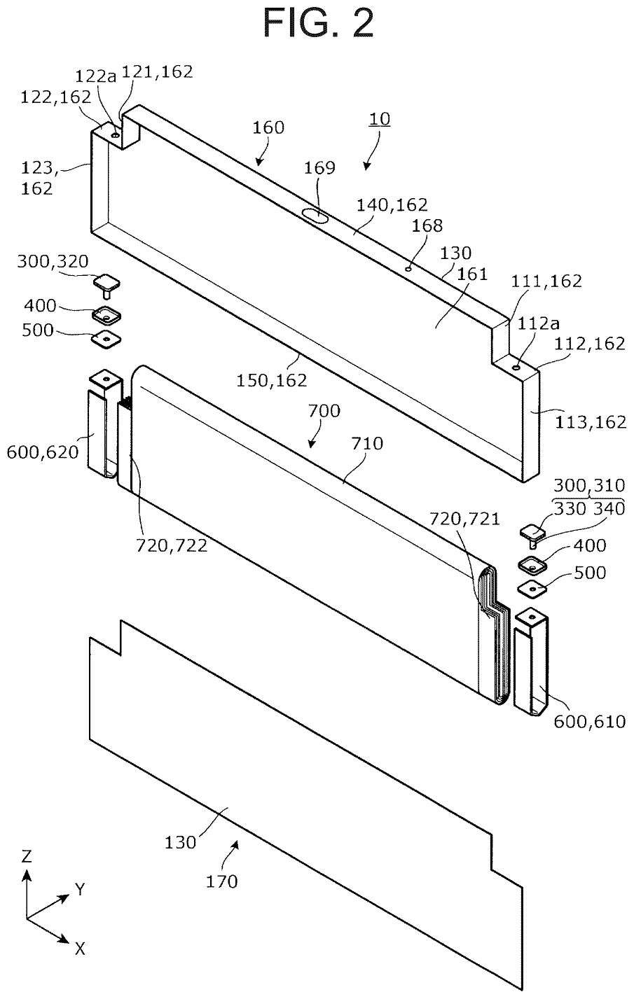

First, a general description of an energy storage device 10 in the present example embodiment will be given with reference to FIGS. 1 and 2. FIG. 1 is a perspective view illustrating an external appearance of the energy storage device 10 according to the example embodiment. FIG. 2 is an exploded perspective view obtained by disassembling the energy storage device 10 according to the example embodiment and showing elements thereof.

The energy storage device 10 is an energy storage device which can be charged with electricity from outside and can discharge electricity to the outside. In the present example embodiment, the energy storage device 10 has a substantially rectangular parallelepiped shape. The energy storage device 10 is a battery used for a power storage application, a power supply application, or the like. Specifically, the energy storage device 10 is used as a battery or the like for driving or starting an engine of a movable body such as an automobile, a motorcycle, a watercraft, a vessel, a snowmobile, an agricultural machine, a construction machine, an automatic guided vehicle (AGV), or a railway vehicle for an electric railway. As the above-mentioned automobile, electric vehicles (EVs), hybrid electric vehicles (HEVs), plug-in hybrid electric vehicles (PHEVs), and fossil fuel (gasoline, light oil, liquefied natural gas, or the like) automobiles are exemplified. As the above-mentioned railway vehicle for an electric railway, trains, monorails, linear induction motor trains, and hybrid trains provided with both a diesel engine and an electric motor are exemplified. The energy storage device 10 can also be used as a stationary battery or the like for use at home, business, or the like.

The energy storage device 10 is not limited to a non-aqueous electrolyte secondary battery, and may be a secondary battery other than the non-aqueous electrolyte secondary battery, or may be a capacitor. The energy storage device 10 may be a primary battery instead of a secondary battery. The energy storage device 10 may be a battery using a solid electrolyte. The energy storage device 10 may be a pouch-type energy storage device. In the present example embodiment, the energy storage device 10 based on a flat rectangular parallelepiped shape (which is substantially rectangular parallelepiped shaped) is illustrated. However, the shape of the energy storage device 10, that is, the shape of a container 100, is not limited to a shape based on a rectangular parallelepiped shape, and may be a shape based on a polygonal prism shape, a long cylindrical shape, an elliptic cylindrical shape, a cylindrical shape, or the like other than the rectangular parallelepiped shape.

As illustrated in FIGS. 1 and 2, the energy storage device 10 includes the container 100, a pair of terminals 300, and a pair of outer gaskets 400. A pair of inner gaskets 500, a pair of current collectors 600, and an electrode body 700 are accommodated inside the container 100. Specifically, members of a positive pole (one of the terminals 300, one of the outer gaskets 400, one of the inner gaskets 500, one of the current collectors 600, and the like, the same applies hereinafter) are located at one end portion of the container 100 in the X-axis positive direction. Members of a negative pole are located at an other end portion of the container 100 in the X-axis negative direction.

While an electrolytic solution (non-aqueous electrolyte) is sealed in the container 100, illustration thereof is omitted. The type of the electrolytic solution is not particularly limited as long as the electrolytic solution does not impair the performance of the energy storage device 10, and various solutions may be selected as the electrolytic solution. Apart from the elements described above, a spacer located lateral to, above, or below the electrode body 700, and an insulator film which insulates the electrode body 700 and the current collectors 600 from the container 100, for example, may be located.

The container 100 is a case having an outer shape based on a flat rectangular parallelepiped shape (which is substantially rectangular parallelepiped shaped) elongated in the X-axis direction. The length of the container 100 in the X-axis direction is three times or more greater than the length of the container 100 in the Z-axis direction. The length of the container 100 in the X-axis direction is five times or more greater than the length of the container 100 in the Y-axis direction. In FIG. 1, the rectangular parallelepiped shape which serves as a basis is indicated by a two-dot chain line L1. Specifically, a pair of cutout portions 101 shaped in a rectangular parallelepiped are formed at an upper portion of both ends of the container 100 in the X-axis direction. Thus, the container 100 is of a rectangular or substantially rectangular (including a square) having the pair of cutout portions 101 formed by cutting out a pair of adjacent corner portions as seen in the Y-axis direction. The pair of cutout portions 101 are located in the X-axis direction. Of the pair of cutout portions 101, the cutout portion 101 in the X-axis positive direction is referred to as a first cutout portion 110, and the cutout portion 101 in the X-axis negative direction is referred to as a second cutout portion 120.

Specifically, the first cutout portion 110 is formed of a first side surface 111 of a rectangular shape parallel to a YZ plane, and a first upper surface 112 of a rectangular shape extending in the X-axis positive direction from a lower end of the first side surface 111 and being parallel to an XY plane. The first cutout portion 110 is a portion in which the corner portion of the container 100 in the X-axis positive direction and a Z-axis positive direction is cut out in a quadrangular shape (L shape) when viewed from the Y-axis direction.

The second cutout portion 120 is formed of a second side surface 121 of a rectangular shape parallel to the YZ plane, and a second upper surface 122 of a rectangular shape extending in the X-axis negative direction from a lower end of the second side surface 121 and being parallel to the XY plane. The second cutout portion 120 is a portion in which the corner portion of the container 100 in the X-axis negative direction and the Z-axis positive direction is cut out in a quadrangular shape (L shape) when viewed from the Y-axis direction.

In the container 100, long side surfaces 130 are both end surfaces that are opposed to each other in the Y-axis direction.

Each of the long side surfaces 130 is a flat surface that is parallel to an XZ plane and elongated in the X-axis direction, and both end portions thereof in the X-axis direction have a shape corresponding to the respective cutout portions 101.

In the container 100, short side surfaces 113 and 123 are surfaces on both ends of the container 100 that are opposed to each other in the X-axis direction. The short side surface 113 is a flat surface of a rectangular shape whose upper end is contiguous with the first upper surface 112 and which is parallel to the YZ plane. The short side surface 123 is a flat surface of a rectangular shape whose upper end is contiguous with the second upper surface 122 and which is parallel to the YZ plane.

Of both end surfaces of the container 100 that are opposed to each other in the Z-axis direction, an end surface in the Z-axis positive direction is an upper surface 140, and an end surface in a Z-axis negative direction is a lower surface 150. The upper surface 140 is a flat surface connecting an upper end of the first side surface 111 and an upper end of the second side surface 121, and is a rectangular flat surface parallel to the XY plane. The lower surface 150 is a flat surface connecting a lower end of the short side surface 113 and a lower end of the short side surface 123, and is a rectangular flat surface parallel to the XY plane.

The container 100 includes a container body 160 and a container lid 170. The container 100 is formed in a substantially rectangular parallelepiped shape by assembling the container body 160 with the container lid 170. The container body 160 includes the long side surface 130 at a Y-axis positive direction, the upper surface 140, the lower surface 150, the short side surfaces 113 and 123, the first side surface 111, the first upper surface 112, the second side surface 121, and the second upper surface 122.

The container body 160 has a shape in which one long sidewall of a pair of long sidewalls of a substantially rectangular parallelepiped is removed. In other words, the container body 160 is a box having an opening, more specifically, a box in which a wall at one side in a thickness direction (a Y-axis negative direction) of a substantially rectangular parallelepiped having short sidewalls and long sidewalls is opened. The container body 160 includes a bottom wall 161, which is flat plate-shaped, and a sidewall 162 extending from an entire periphery of the bottom wall 161 in the Y-axis negative direction. The bottom wall 161 is an example of a first wall portion, and the sidewall 162 is an example of a second wall portion. The sidewall 162 is formed of the upper surface 140, the lower surface 150, the short side surfaces 113 and 123, the first side surface 111, the first upper surface 112, the second side surface 121, and the second upper surface 122. The sidewall 162 forms an opening in which the electrode body 700 and the like are accommodated. The bottom wall 161 includes one long side surface of the pair of long side surfaces 130 of the container 100.

A length between the short side surface 113 of the sidewall 162 and the short side surface 123 of the sidewall 162 in the container body 160 is three times or more greater than a length between the upper surface 140 of the sidewall 162 and the lower surface 150 of the sidewall 162 in the container body 160. In other words, a length of the long side of the bottom wall 161 (i.e., the length of the side in the X-axis direction) is three times or more greater than a length of the short side of the bottom wall 161 (i.e., the length of the side in the Z-axis direction) when viewed in a layering direction of polar plates (i.e., the Y-axis direction, the first direction). The length between the short side surface 113 of the sidewall 162 and the short side surface 123 of the sidewall 162 in the container body 160 is five times or more greater than a height of the sidewall 162. In other words, the length of the long side of the bottom wall 161 (i.e., the length of the side in the X-axis direction) is five times or more greater than the height of the sidewall 162 (i.e., the length of the side in the Y-axis direction).

The container lid 170 covers an opening formed by the sidewall 162 of the container body 160. The container lid 170 is joined to the sidewall 162. The container lid 170 includes an other long side surface of the pair of long side surfaces 130 of the container 100. Therefore, the pair of long side surfaces 130 of the container 100 correspond to a surface of the bottom wall 161 and a surface of the container lid 170. With such a configuration, after accommodating the electrode body 700 and the like in the opening of the container body 160, the container body 160 and the container lid 170 are joined by welding or the like, whereby the container 100 is sealed. Although the material of the container 100 (the container body 160 and the container lid 170) is not particularly limited, preferably, a weldable metal, such as stainless steel, aluminum, an aluminum alloy, iron, or a plated steel plate, should be used.

A liquid injection portion 168 and a gas discharge valve 169 are formed in the container body 160. The gas discharge valve 169 is a safety valve which releases pressure inside the container 100 when the pressure is raised excessively. The liquid injection portion 168 is a part for injecting an electrolytic solution into the container 100 when manufacturing the energy storage device 10.

The terminals 300 are terminals (a positive electrode terminal 310 and a negative electrode terminal 320) that are electrically connected to the electrode body 700 via the current collectors 600. In other words, the terminal 300 is a metallic member for delivering electricity stored in the electrode body 700 to an outer space of the energy storage device 10, and for introducing electricity into an internal space of the energy storage device 10 in order to store the electricity in the electrode body 700. Although the material of the terminal 300 is not particularly limited, the terminal 300 is formed of a conductive member such as aluminum, an aluminum alloy, copper, or a copper alloy. The terminal 300 is connected (joined) to the current collector 600 and is also attached to the container body 160 by joining by caulking, welding, or the like.

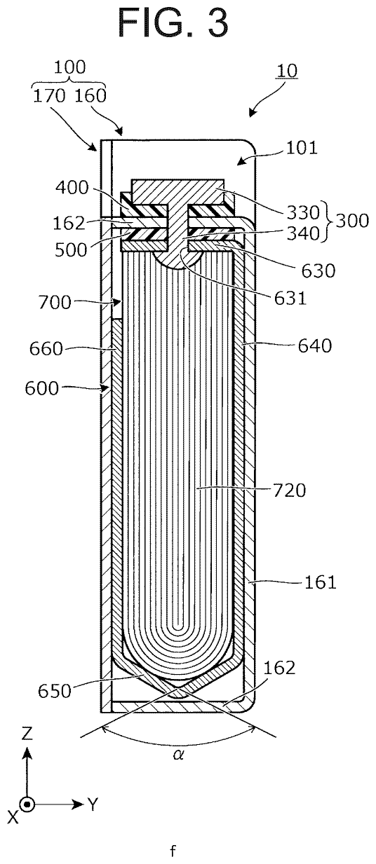

FIG. 3 is a cross-sectional view illustrating the structure of connection between the terminal 300 according to the example embodiment and the current collector 600 and the like. FIG. 3 is a cross-sectional view of a cross section taken along line III-III of FIG. 1. Although FIG. 3 illustrates the structure of connection of the members of the positive pole, the structure of connection of the members of the negative pole is basically the same.

As illustrated in FIG. 3, the terminal 300 includes a terminal body portion 330, and a shaft portion 340 projecting from the terminal body portion 330. The terminal body portion 330 is a part located on an outer side relative to a terminal installation surface of the container 100. The terminal 300 (the terminal body portion 330) is projected from the terminal installation surface of the container 100 in the Z-axis direction (the third direction). The terminal installation surface of the present example embodiment corresponds to the first upper surface 112 and the second upper surface 122. With respect to the terminal installation surface, at places corresponding to the respective terminal installation surfaces which are the surfaces where the terminal body portions 330 are installed via the outer gaskets 400, through holes 112a and 122a through which the shaft portions 340 penetrate are formed. The shaft portion 340 is connected (joined) to the current collector 600 by being caulked in a state in which the shaft portion 340 penetrates through the terminal installation surface, the outer gasket 400, the inner gasket 500, and the current collector 600.

The current collectors 600 are located at both end portions (a positive-side end portion and a negative-side end portion in the second direction) of the electrode body 700 in the X-axis direction, respectively. The current collectors 600 are members (a positive electrode current collector 610 and a negative electrode current collector 620) having conductivity which are respectively connected (joined) to the electrode body 700 and the terminal 300, and electrically connect the electrode body 700 and the terminal 300. Although the material of the current collectors 600 is not particularly limited, the positive electrode current collector 610 is formed of a conductive member such as aluminum or an aluminum alloy, and the negative electrode current collector 620 is formed of a conductive member such as copper or a copper alloy.

Specifically, the current collector 600 is formed by bending a single sheet metal. The current collector 600 includes a terminal connection portion 630, an intermediate portion 640, a bent portion 650, and an electrode body connection portion 660.

The terminal connection portion 630 is a flat plate-shaped part which is connected (joined) to the terminal 300 by joining by caulking, welding, or the like. Specifically, the terminal connection portion 630 includes a through hole 631, and to the terminal connection portion 630, a distal end of the shaft portion 340 of the terminal 300 penetrating through the through hole 631 is caulked. The terminal connection portion 630 is connected to the shaft portion 340 in a posture along the sidewall 162.

The intermediate portion 640 is a flat plate-shaped part which extends from the terminal connection portion 630 along the bottom wall 161. The intermediate portion 640 is connected to an end portion of the terminal connection portion 630 in the Y-axis positive direction, is bent at a peripheral edge of the distal end (caulked portion) of the shaft portion 340 of the terminal 300, and extends along the bottom wall 161. The intermediate portion 640 is located between the bottom wall 161 and a connection portion 720 (described later) of the electrode body 700 in a posture along the bottom wall 161.

The bent portion 650 is a bent plate-like part which is bent in a shape facing the terminal connection portion 630 from the intermediate portion 640. Specifically, the bent portion 650 is connected to an end portion of the intermediate portion 640 in the Z-axis negative direction, and is bent such that a distal end portion of the bent portion 650 faces the terminal connection portion 630. The bent portion 650 is bent in a V-shape as seen in the X-axis direction. An angle α formed by the bent portion 650 is arbitrary. If the angle α is 90 degrees or more, the bent portion 650 can be formed along a curved portion 711 of the electrode body 700, so the angle α should preferably be 90 degrees or more. The bent portion 650 may have any shape as long as the distal end portion faces the terminal connection portion 630. As the shape of the bent portion 650 other than the V-shape, a U-shape, a shape of bellows, and the like, are given as examples.

The electrode body connection portion 660 is a flat plate-shaped part which is connected (joined) to the connection portion 720 (described later) of the electrode body 700 by welding, joining by caulking, or the like. The electrode body connection portion 660 extends from the bent portion 650 in a shape to approach the terminal connection portion 630. The electrode body connection portion 660 overlaps the intermediate portion 640 in a plan view (as seen in the Y-axis direction) of the intermediate portion 640. The electrode body connection portion 660 is located between the connection portion 720 and the container lid 170 in a posture along the container lid 170, and is connected to the connection portion 720.

The outer gasket 400 is a plate-like and rectangular insulating seal member which is located between the container body 160 of the container 100 and the terminal 300 to insulate the container body 160 and the terminal 300 from each other and to seal between the container body 160 and the terminal 300. The inner gasket 500 is a plate-like and rectangular insulating seal member which is located between the container body 160 and the current collector 600 to insulate the container body 160 and the current collector 600 from each other and to seal between the container body 160 and the current collector 600. The outer gasket 400 and the inner gasket 500 are formed of an electrically insulating resin such as polypropylene (PP), polyethylene (PE), polystyrene (PS), ABS resin, or a composite material thereof.

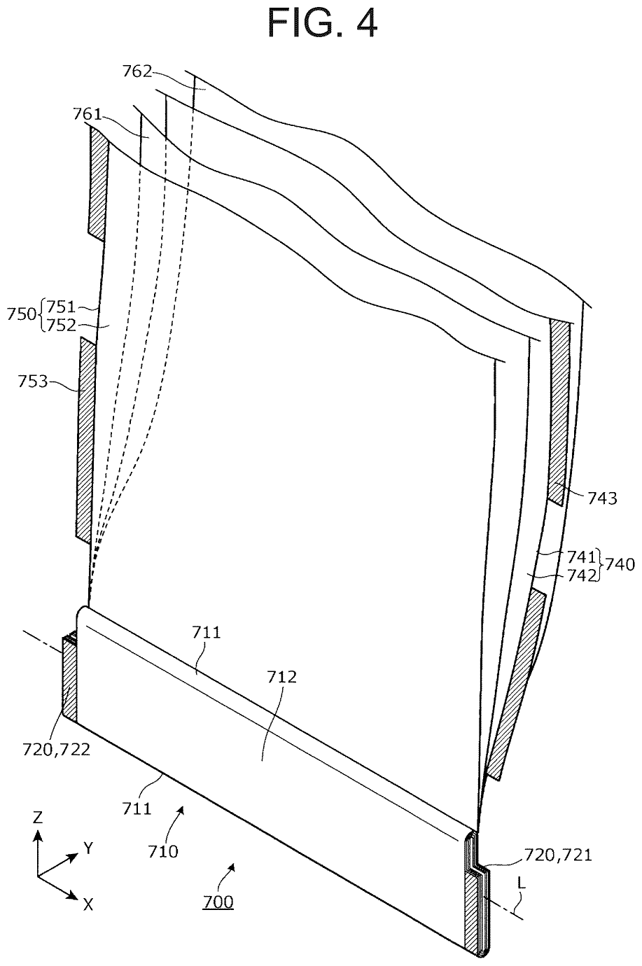

The electrode body 700 is an energy storage element (power generation element) formed by winding the polar plates. As illustrated in FIG. 4, the electrode body 700 is located such that a winding axis L is oriented along the X-axis direction. The electrode body 700 is of an elongated shape extending in the X-axis direction, and has an oval shape when viewed from the X-axis direction. In the present example embodiment, the X-axis direction corresponds to a direction in which the pair of short side surfaces 113 and 123 of the container 100 are opposed to each other. The electrode body 700 has a shape whose length in the X-axis direction is 300 mm or more, or specifically, a shape which is extended in the X-axis direction (the second direction) for about 500 mm to 1500 mm. Thus, the length of the electrode body 700 in the X-axis direction is greater than the length thereof in the Z-axis direction (the third direction). In the electrode body 700, the length in the X-axis direction is three times or more greater than the length in the Z-axis direction. The electrode body 700 includes a body portion 710, and two connection portions 720 projecting from the body portion 710 to the both end portions in the X-axis direction (i.e., the positive-side end portion and the negative-side end portion in the second direction). As described above, the connection portions 720 are connected (joined) to the current collectors 600, respectively. The direction in which the connection portion 720 is projected from the body portion 710 is along the axis (the winding axis L) around which the polar plates are wound.

Specifically, the two connection portions 720 are projected from both end surfaces of the body portion 710 in the X-axis direction, respectively. On one end surface of the body portion 710 in the X-axis positive direction, a positive electrode connection portion 721 is provided at a predetermined interval from an end portion of the body portion 710 in the Z-axis positive direction. Meanwhile, on an other end surface of the body portion 710 in the X-axis negative direction, a negative electrode connection portion 722 is provided at a predetermined interval from an end portion of the body portion 710 in the Z-axis positive direction. As illustrated in FIG. 2, the electrode body 700 has a rectangular or substantially rectangular in which corner portions in a plan view of a flat portion 712 to be described later, are cut out. The cut out portions correspond to portions spaced apart with the predetermined interval as described above. Therefore, the electrode body 700 has a protruding portion on a positive side in the Z-axis direction. Such a configuration of the electrode body 700 will be described in detail below.

FIG. 4 is a perspective view illustrating a configuration of the electrode body 700 according to the example embodiment. Specifically, FIG. 4 illustrates the configuration of the electrode body 700 in a state in which the polar plates being wound are partially unwound. As illustrated in FIG. 4, the electrode body 700 includes a positive plate 740, a negative plate 750, and separators 761 and 762.

The positive plate 740 is the polar plate (an electrode plate) made by forming a positive electrode active material layer 742 on a surface of positive electrode current collector foil 741, which is strip-shaped metal foil. Aluminum, an aluminum alloy, or the like, is used for the positive electrode current collector foil 741. The negative plate 750 is the polar plate (an electrode plate) made by forming a negative electrode active material layer 752 on a surface of negative electrode current collector foil 751, which is strip-shaped metal foil. Copper, a copper alloy, or the like, is used for the negative electrode current collector foil 751. As a positive electrode active material used for the positive electrode active material layer 742 and a negative electrode active material used for the negative electrode active material layer 752, known materials can be used as appropriate as long as they are a positive electrode active material and a negative electrode active material that can occlude and release lithium ions.

As the positive electrode active material, polyanion compounds such as LiMPO₄, LiMSiO₄, and LiMBO₃ (where M is one or more transition metal elements selected from Fe, Ni, Mn, Co, and the like), lithium titanate, spinel-type lithium-manganese oxides such as LiMn₂O₄ and LiMn_{1.5}Ni_{0.5}O₄, lithium-transition metal oxides such as LiMO₂ (where M is one or more transition metal elements selected from Fe, Ni, Mn, Co, and the like), or the like, may be used. As the negative electrode active material, lithium metals, alloys capable of occluding and releasing lithium, carbon materials (e.g., graphite, non-graphitizable carbon, easily graphitizable carbon, low-temperature baked carbon, and amorphous carbon), silicon oxides, and the like, are given as examples.

The separators 761 and 762 are microporous sheets made of a resin. As the material of the separators 761 and 762, a known material can be used as appropriate as long as the material does not impair the performance of the energy storage device 10. As the separators 761 and 762, a woven fabric or a nonwoven fabric which is insoluble in an organic solvent, a synthetic resin microporous film which is made of a polyolefin resin such as polyethylene, and the like, may be used.

The electrode body 700 is formed by winding the positive plate 740, the negative plate 750, and the separators 761 and 762. In other words, the electrode body 700 is formed by layering the negative plate 750, the separator 761, the positive plate 740, and the separator 762 in this order, and winding these layered elements. In the present example embodiment, as the positive plate 740, the negative plate 750, and the like, are wound around the winding axis L, a wound type electrode body 700 is formed. The winding axis L is a virtual axis serving as a central axis when the positive plate 740, the negative plate 750, and the like, are wound. The winding axis L of the present example embodiment is a straight line that passes through a center of the electrode body 700, and is parallel to the X-axis direction. The electrode body 700 is located within the container 100 such that the winding axis L is oriented along the direction (second direction) in which the short side surfaces 113 and 123 of the container 100 are opposed to each other.

A plurality of projecting pieces 743 are located at an interval from each other at one edge (an edge in the X-axis positive direction) of the positive plate 740 in the winding axis direction. Similarly, a plurality of projecting pieces 753 are located at an interval from each other at an other edge (an edge in the X-axis negative direction) of the negative plate 750 in the winding axis direction. The projecting pieces 743 and the projecting pieces 753 are portions (an active material layer non-formed portion) where an active material layer containing an active material is not formed and the metal foil (the current collector foil) is exposed. A shaded area in FIG. 4 corresponds to the active material layer non-formed portion.

When the positive plate 740, the negative plate 750, and the separators 761 and 762 are wound, the projecting pieces 743 of the positive plate 740 overlap one another at the one end surface of the body portion 710. A portion where the projecting pieces 743 of the positive plate 740 overlap one another is the positive electrode connection portion 721. Similarly, the projecting pieces 753 of the negative plate 750 overlap one other at the other end surface of the body portion 710. A portion where the projecting pieces 753 of the negative plate 750 overlap one another is the negative electrode connection portion 722.

The body portion 710 is a long cylindrical shaped part (an active material layer formed portion) formed by winding a portion where the positive electrode active material layer 742 is formed (coated), a portion where the negative electrode active material layer 752 is formed (coated), and the separators 761 and 762. The body portion 710 includes a pair of curved portions 711 on both sides in the Z-axis direction, and includes a flat portion 712 having a flat shape between the pair of curved portions 711. It can also be said that the pair of curved portions 711 are located at positions sandwiching the flat portion 712 therebetween in the Z-axis direction.

Each of the curved portions 711 is a curved part in which an arc shape of an end portion in the Z-axis direction when viewed from the X-axis direction extends in the X-axis direction. The curved portions 711 are opposed to the upper surface 140 and the lower surface 150, which are parts of the sidewall 162 of the container body 160. In other words, the pair of curved portions 711 are parts that are curved so as to project from the flat portion 712 to both sides in the Z-axis direction when viewed from the X-axis direction.

The flat portion 712 is a rectangular and flat-shaped part which connects the end portions of the pair of curved portions 711 to each other, and extends parallel to an XZ plane. The flat portion 712 is opposed to the bottom wall 161 of the container body 160 and the container lid 170. In the flat portion 712 mentioned above, a plurality of wound polar plates (the positive plate 740 and the negative plate 750) are layered in the Y-axis direction (the first direction). That is, in the flat portion 712, the Y-axis direction (the first direction) is the layering direction of the plurality of polar plates. In the present example embodiment, the electrode body 700 is accommodated in the container 100 such that the layering direction of the polar plates in the flat portion 712 of the electrode body 700 conforms to the Y-axis direction (the first direction). The electrode body 700 overlaps the bottom wall 161 of the container body 160 as seen in the layering direction (see FIG. 3).

The curved shape of the curved portion 711 is not limited to a semicircular arc shape, and may be, for example, a portion of an elliptical shape, or may be curved in any shape. An outer surface of the flat portion 712 facing the Y-axis direction is not limited to a flat surface, and the outer surface may be slightly recessed or slightly bulged.

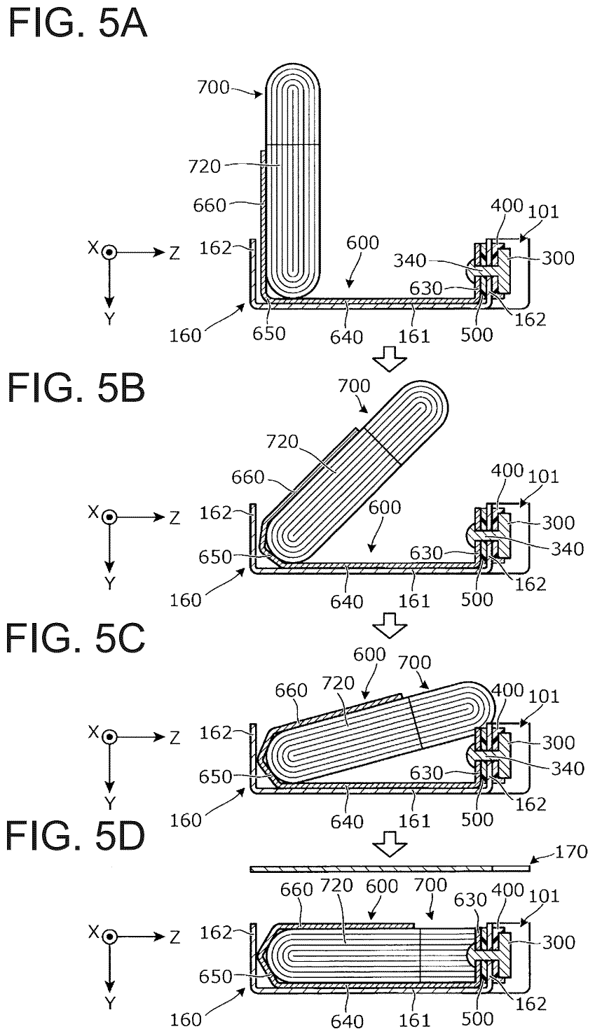

Next, a method of manufacturing the energy storage device 10 will be described. FIGS. 5A to 5D are explanatory diagrams illustrating a method of manufacturing the energy storage device 10 according to the example embodiment. In FIGS. 5A to 5D, steps progress in the order of (a), (b), (c), and (d). Although FIGS. 5A to 5D illustrate the structure of connection of the members of the positive pole of the energy storage device 10, the same applies to the structure of connection of the members of the negative pole. Although a case where each step is executed by a manufacturing apparatus is exemplified, a worker may execute each step.

As illustrated in FIG. 5A, first, the manufacturing apparatus joins the current collector 600 to the shaft portion 340 of the terminal 300 by caulking in a state in which the outer gasket 400, the inner gasket 500, and the terminal 300 are located at the cutout portion 101 (the terminal installation surface) of the container body 160. Specifically, one end portion (the terminal connection portion 630) of the current collector 600 is joined to the shaft portion 340 of the terminal 300 in a posture along the sidewall 162 of the container body 160. At this time, a portion of the current collector 600 that overlaps the bottom wall 161 of the container body 160 constitutes the intermediate portion 640. An other end portion (the electrode body connection portion 660) of the current collector 600 is in a state of being raised with respect to the bottom wall 161 of the container body 160. A portion between the intermediate portion 640 and the electrode body connection portion 660 constitutes the bent portion 650. In this state, the manufacturing apparatus joins the connection portion 720 of the electrode body 700 to the electrode body connection portion 660 of the current collector 600. As a result, the electrode body 700 is in a state of being raised with respect to the bottom wall 161 of the container body 160. Specifically, the flat portion 712 of the electrode body 700 is raised to be along the first direction. In a state in which the current collector 600 is raised with respect to the bottom wall 161, the current collector 600 need not form a right angle with respect to the bottom wall 161. In the work of joining the current collector 600 and the electrode body 700, it suffices that the electrode body 700 is raised at an angle at which the electrode body 700 does not interfere with the bottom wall 161.

Then, as illustrated in FIGS. 5B and 5C, the manufacturing apparatus leans the electrode body connection portion 660 and the electrode body 700, and gradually deforms the bent portion 650. Finally, as illustrated in FIG. 5D, the electrode body connection portion 660 of the current collector 600 and the electrode body 700 are in a posture along the bottom wall 161. Specifically, the manufacturing apparatus presses the electrode body connection portion 660 or the electrode body 700, thereby deforming the bent portion 650. At this time, since the electrode body connection portion 660 is located at substantially the same position as the bent portion 650 and the intermediate portion 640 in the X-axis direction, the bent portion 650 is smoothly deformed when the electrode body connection portion 660 or the electrode body 700 is pressed. In a deformed state, the electrode body connection portion 660 overlaps the intermediate portion 640 in a plan view (as seen in the Y-axis direction) of the intermediate portion 640. A thickness of a portion to be bent of the bent portion 650 may be made thinner than a thickness of other parts of the bent portion 650. The bent portion 650 is enabled to be easily bent by reducing the thickness of the portion to be bent of the bent portion 650.

As described above, by deforming the current collector 600, the electrode body 700 can be made to be inclined above the bottom wall 161, and the electrode body 700 can be located in a posture along the bottom wall 161. Consequently, friction that the electrode body 700 receives from the bottom wall 161 can be reduced. The electrode body 700 can be smoothly accommodated in the container body 160.

In this state, a distal end portion of the bent portion 650 is shaped to face the terminal connection portion 630. An end portion of the body portion 710 of the electrode body 700 in the Z-axis positive direction is located between the pair of cutout portions 101 of the container body 160 (see FIGS. 5C and 5D).

Then, the manufacturing apparatus closes the opening formed by the sidewall 162 of the container body 160 with the container lid 170, and joins the container lid 170 to the sidewall 162.

As described above, according to the example embodiment of the present invention, during manufacturing, one end portion (the terminal connection portion 630) of the current collector 600 is joined to the terminal 300 in a state in which the one end portion overlaps the sidewall 162 (the second wall portion) of the container body 160, and the other end portion (the electrode body connection portion 660) of the current collector 600 is made to rise with respect to the bottom wall 161 (the first wall portion) of the container body 160. After that, after joining the electrode body 700 to the electrode body connection portion 660, a portion between one end portion of the current collector 600 and the other end portion of the current collector 600 is bent, whereby the electrode body connection portion 660 and the electrode body 700 approach the terminal connection portion 630. By doing so, in a state in which the electrode body connection portion 660 and the electrode body 700 are joined, the electrode body 700 can be smoothly located along the bottom wall 161 of the container body 160. That is, during manufacturing of such an energy storage device 10, the electrode body 700 can be smoothly located along the bottom wall 161. Thus, damage to the electrode body 700 can be reduced or prevented.

Even in the container body 160 in which the sidewall 162 is raised from a pair of edge portions (an upper edge and a lower edge of the bottom wall 161) opposed to each other in the Z-axis direction among peripheral edges of the bottom wall 161, it is possible to smoothly dispose the electrode body 700 along the bottom wall 161 during manufacturing. Therefore, even in such a container body 160, it is possible to reduce or prevent a load applied to the electrode body 700 during manufacturing.

Since the current collector 600 and the terminal 300 are attached to the sidewall 162 corresponding to the cutout portion 101, it is possible to dispose a part (the body portion 710, the protruding portion of the electrode body 700) which contributes to power generation (storage of electricity) of the electrode body 700 between the pair of cutout portions 101. Therefore, a redundant space in the container 100 can be reduced, and energy density of the energy storage device 10 can be increased. The body portion 330 of the terminal 300 is located at each portion of a pair of cut out parts. Consequently, in electrically connecting a plurality of energy storage devices 10 to each other, a busbar for electrical connection can be located in the cut out parts (the cutout portions 101). Therefore, the cutout portions 101 can be effectively used.

In the present example embodiment, the bent portion 650 which is a starting point of the bending of the current collector 600 is provided at a position distant from the terminal connection portion 630, that is, a position distant from between the pair of cutout portions 101. Thus, when the body portion 710 is located between the pair of cutout portions 101, it is possible to prevent the end portion of the body portion 710 in the Z-axis positive direction from interfering with the sidewall 162.

Since the bent portion 650 is bent in a V-shape, a total length of the bent portion 650 can be made short. Therefore, it is possible to reduce or prevent an increase in the size of the current collector 600.

Since the intermediate portion 640 and the electrode body connection portion 660 overlap one another in a plan view of the intermediate portion 640, the bent portion 650 can be smoothly deformed during manufacturing. Since the bent portion 650 can be smoothly deformed, a load applied to the electrode body 700 can be further reduced or prevented.

In the above, the energy storage device according to the example embodiment of the present invention has been described. However, the present invention is not limited to the above-described example embodiment. The example embodiment disclosed herein is illustrative in all aspects, and the scope of the present invention includes all modifications within the meaning and scope of the claims and the doctrine of equivalents.

In the above-described example embodiments, exemplified is the case where the container 100 having a substantially rectangular parallelepiped shape includes a first container member, which is the container body 160 in which only one surface is opened, and a second container member, which is the container lid 170 that closes the one surface. That is, In the above-described example embodiments, the first container member forms five faces of the six faces that constitute the substantially rectangular parallelepiped shape, and the second container member forms one face. The faces of the substantially rectangular parallelepiped shape formed by the first container member and the second container member may be set anyhow. The first container member may form four faces and the second container member may form two faces among the six faces that constitute the substantially rectangular parallelepiped shape. Alternatively, the first container member may form three faces and the second container member may form the remaining three faces among the six faces that constitute the substantially rectangular parallelepiped shape.

In the above-described example embodiments, the container 100 having the pair of cutout portions 101 has been exemplified. The number of cutout portions to be provided may be any, and no cutout portions may be provided in the container.

In the above-described example embodiments, the case where only one electrode body 700 is accommodated in the container 100 has been exemplified. However, a plurality of electrode bodies may be accommodated in the container.

In the above-described example embodiments, the wound type electrode body 700 has been exemplified. However, the shape of the electrode body is not limited to the wound type, and may be, for example, a stacked type in which flat plate-shaped polar plates are layered, or of a shape in which the polar plates and/or separators are folded in a shape of bellows (a form in which a rectangular polar plate is sandwiched between the separators that are folded in the shape of bellows, a form in which the polar plates and the separators are stacked and then folded in the shape of bellows, or the like). In either case, it is sufficient if the layering direction of the electrode body conforms to the Y-axis direction and the electrode body overlaps the bottom wall of the container body as seen in the layering direction. The electrode body which is of a stacked type or has a folded form in the shape of bellows includes a tab portion projecting in the X-axis direction, and the tab portion and the current collector 600 are joined. The tab portion may be a separate body different from the electrode body 700 or may be formed integrally with the electrode body 700.

In the above-described example embodiments, the electrode body 700 in which the connection portion 720 is projected from only a portion of the body portion 710 has been exemplified. The electrode body may be one in which the connection portion is projected from the entire body portion.

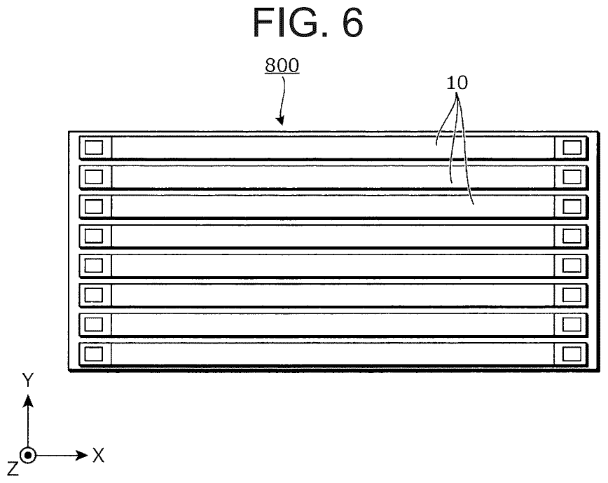

The energy storage device of the above-described example embodiments and the like may be used in an energy storage apparatus. In this case, the techniques of example embodiments of the present invention may be applied to at least one energy storage device provided in the energy storage apparatus. FIG. 6 is an explanatory diagram illustrating an energy storage apparatus including the energy storage device according to an example embodiment. As illustrated in FIG. 8, a plurality of energy storage devices 10 are located inside an energy storage apparatus 800. The energy storage apparatus 800 may include a busbar (not illustrated) which electrically connects the energy storage devices 10 to each other. The energy storage apparatus 800 may be provided with a state monitoring device (not illustrated) which monitors the state of one or more energy storage devices 10.

Configurations that are constructed by arbitrarily combining the elements included in the above-described example embodiments and the modification examples thereof are also included in the scope of the present invention.

Example embodiments of the present invention can be applied to energy storage devices such as lithium-ion secondary batteries.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage device comprising:
an electrode body;
a current collector electrically connected to the electrode body;
a container accommodating therein the electrode body and the current collector; and
a terminal attached to the container and is electrically connected to the current collector; wherein
the container includes a container body and a container lid joined to the container body;
the container body includes:
a first wall portion; and
a second wall portion extending from at least a portion of a peripheral edge of the first wall portion; and
the current collector includes:
a terminal connection portion joined to the terminal;
an intermediate portion extending from the terminal connection portion along the first wall portion;
a bent portion facing the terminal connection portion from the intermediate portion; and
an electrode body connection portion extending from the bent portion to approach the terminal connection portion and joined to the electrode body.

2. The energy storage device according to claim 1, wherein the second wall portion extends from a pair of edge portions opposed to each other in a direction in which the intermediate portion extends among the peripheral edges of the first wall portion.

3. The energy storage device according to claim 2, wherein
the first wall portion has a rectangular or substantially rectangular in which adjacent corner portions are cut out in a plan view; and
the current collector and the terminal are attached to the second wall portion corresponding to a cutout portion in the first wall portion.

4. The energy storage device according to claim 1, wherein the bent portion is bent in a V-shape or approximate V-shape.

5. The energy storage device according to claim 1, wherein the electrode body connection portion overlaps the intermediate portion in a plan view of the intermediate portion.
